(19) United States
(12) Patent Application Publication
(10) Pub. No.: US 2007/0044938 A1
(43) Pub. Date: Mar. 1, 2007

(54) Dual surge tank for vehicle cooling system

(76) Inventor: Mary L. Farley, Sterling Heights, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/213,489

(22) Filed: Aug. 26, 2005

(51) Int. Cl. B60H 1/00

(52) U.S. Cl. 165/41; 165/104.32

(57) ABSTRACT

The invention concerns a dual surge tank for use in a cooling system of a vehicle. The dual surge tank includes a housing having an outer wall defining a container, and a divider, located within the housing, dividing the container into a first chamber adapted to contain a first liquid and a second chamber adapted to contain a second liquid, with the divider sealing the first chamber from the second chamber. The divider may provide heat insulation between the two chambers. The first chamber may contain engine coolant and the second chamber may contain electronics coolant.

### BACKGROUND OF INVENTION

The present invention relates generally to a cooling system for a vehicle, and in particular to a surge tank employable with vehicle cooling systems.

Conventional vehicles powered by internal combustion engines typically have an engine cooling system that uses a liquid (usually a mixture of water and antifreeze) to maintain the engine within a desired range of operating temperatures. The conventional cooling systems include a radiator for cooling the liquid and a water pump for moving the liquid through the engine and back to the radiator. These cooling systems also typically employ a surge tank (also called a reservoir or an expansion tank) that operates in conjunction with the radiator. The surge tank provides a container for retaining overflow of the engine coolant due to expansion of the coolant as it heats up, and allowing engine coolant to return when coolant in the radiator cools. This is accomplished by allowing positive and vacuum pressures to move coolant between the surge tank and radiator, thus keeping the cooling system properly filled at all times.

Newer types of vehicles, such as hybrid electric vehicles, may also employ an internal combustion engine—including a generally conventional liquid cooling system. Hybrid vehicles may also employ an electronic drive system. These drive systems employ high-powered electrical devices, for example, traction power inverters. Such high-powered electrical devices may need a liquid cooling system to cool the electronics. However, the preferred operating temperature for the electronics is likely to be much lower than for the engine, thus the temperature of the electronics coolant will be less than for the engine coolant. To operate under these different temperatures, the electronics coolant flows through a separate portion of the overall cooling system. This portion of the cooling system, then, will also need a surge tank for retaining overflow of electronics coolant. For this type of hybrid vehicle, a separate surge tank for electronics coolant has been located in the vehicle and connected to the electronics cooling portion of the cooling system.

For such vehicles, the packaging space used and mounting structure needed to mount two surge tanks is more than is desired—especially in a hybrid vehicle where both an internal combustion engine and the electronics for the electric drive portion of the system must be packaged in the vehicle. Moreover, the cost to fabricate and assemble two separate surge tanks, as well as the assembly time needed to mount both in the vehicle, is more than is desirable.

### SUMMARY OF INVENTION

An embodiment of the present invention contemplates a dual surge tank for use in a cooling system of a vehicle. The dual surge tank includes a housing having an outer wall defining a container, and a divider, located within the housing, dividing the container into a first chamber adapted to contain a first liquid and a second chamber adapted to contain a second liquid, wherein the divider seals the first chamber from the second chamber. A first filler opening extends through the outer wall into the first chamber, and a second filler opening extends through the outer wall into the second chamber.

An embodiment according to the present invention may also contemplate a dual surge tank for use in a cooling system of a vehicle. The dual surge tank includes a housing having an outer wall defining a container, and a divider, located within the housing, dividing the container into a first chamber adapted to contain a first liquid and a second chamber adapted to contain a second liquid, wherein the divider seals and is a heat insulator between the first chamber and the second chamber. A first inlet port and a first outlet port each extend through the outer wall into the first chamber, and a second inlet port and a second outlet port each extend through the outer wall into the second chamber.

An embodiment according to the present invention may also contemplate a cooling system for use in a hybrid vehicle including a radiator having an overflow outlet, and a water pump having an inlet. The cooling system may also have a dual surge tank including a housing having an outer wall defining a container; a divider, located within the housing, dividing the container into a first chamber adapted to contain a first liquid and a second chamber adapted to contain a second liquid, wherein the divider seals between the first chamber and the second chamber; a first inlet port extending through the outer wall into the first chamber and in fluid communication with the overflow outlet of the radiator; a first outlet port extending through the outer wall into the first chamber and in fluid communication with the inlet of the water pump; a second inlet port extending through the outer wall into the second chamber and adapted to allow inflow of the second liquid into the second chamber; and a second outlet port extending through the outer wall into the second chamber and adapted to allow outflow of the second liquid from the second chamber.

An advantage of an embodiment of the present invention is that the dual surge tank improves vehicle packaging since package space and mounting hardware are only needed for one surge tank, rather than two, for vehicles that employ separate coolants for different portions of a cooling system. This may be particularly advantageous for hybrid vehicles that have engine coolant used with an internal combustion engine and electronics coolant used with the electronics of an electric drive system.

Another advantage of an embodiment of the present invention is that the overall costs are reduced. Only one set of tooling and one assembly step are required to provide the surge tank functions for two separate portions of a vehicle cooling system.

An additional advantage of an embodiment of the present invention is that the heat from the higher temperature engine coolant in the dual surge tank may be insulated from the lower temperature electronics coolant in the surge tank. Thus, one container provides the surge functions needed for both portions of the cooling system, while still allowing both portions of the cooling system to operate at different temperatures.

### BRIEF DESCRIPTION OF DRAWINGS

FIG. 1 is a perspective view of a portion of a vehicle cooling system in accordance with the present invention.

FIG. 2 is a perspective view of a portion of a vehicle cooling system in accordance with the present invention.

FIG. 3 is a perspective view of a dual surge tank in accordance with the present invention.

FIG. 4 is a perspective view of a dual surge tank in accordance with the present invention.

FIG. 5 is a perspective view of a lower half of a dual surge tank in accordance with the present invention.

FIG. 6 is a perspective view of an upper half of a dual surge tank in accordance with the present invention.

### DETAILED DESCRIPTION

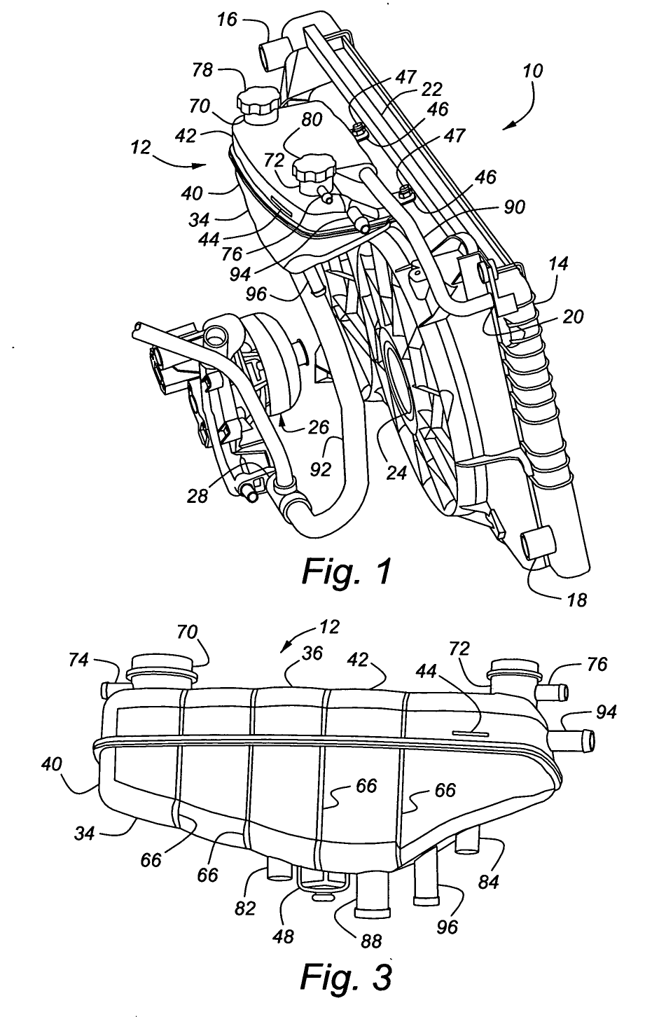

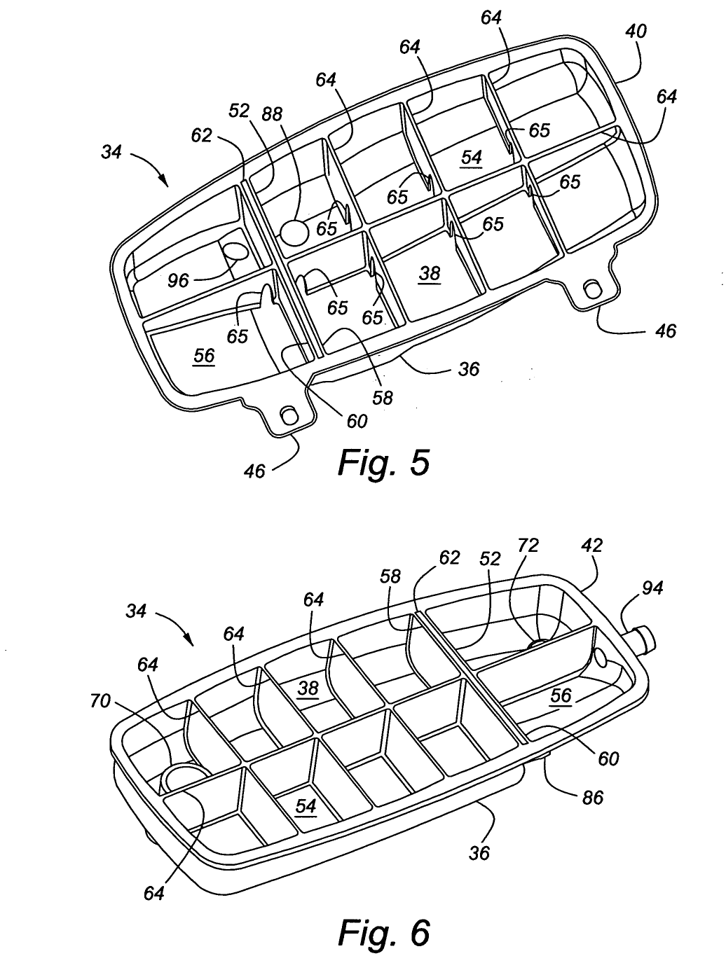

FIGS. 1-6 illustrate a cooling system for a vehicle, indicated generally at 10, that employs a dual surge tank 12. The cooling system 10 includes a radiator 14, with a coolant inlet 16, a coolant outlet 18, and an overflow port 20. Mounted adjacent to the radiator 14 is a fan shroud 22 enclosing a pair of cooling fans 24. A water pump assembly 26 for engine coolant, having an inlet 28, is preferably driven by an internal combustion engine (not shown).

The dual surge tank 12 is composed of a housing 34 having an outer wall 36 that defines a generally hollow container 38. The housing 34 may be formed of a clamshell shaped lower portion 40 and a clamshell shaped upper portion 42. The housing 34 may be made of, for example, a polycarbonate—although other suitable materials may be used instead, if so desired. A fluid level line 44 (shown in FIGS. 1 and 3) may be molded into or marked on the outside of the dual surge tank 12. A second fluid level line (not shown) may also be employed to indicate a desired level for the other chamber (discussed below), if so desired.

Preferably, the dual surge tank 12 mounts on the fan shroud 22. Accordingly, a pair of upper mounting flanges 46 extend from the outer wall 36 and mount on top of the fan shroud 22. The flanges 46 may be secured to the shroud 22 with fasteners 47 or any other suitable means desired. A lower mounting flange 48 extends below the outer wall 36 and may mount to a bracket 50 extending from and mounted to the fan shroud 22. Alternatively, the bracket 50 may be integral with the fan shroud 22 or surge tank 12, if so desired.

The dual surge tank 12 includes a divider 52, which extends across the container 38 to define a first chamber 54 and a second chamber 56. The divider 52 also preferably provides some heat insulation between the first chamber 54 and the second chamber 56. This heat insulating may be effected by the divider 52 having a first divider wall 58 spaced from a second divider wall 60 to form an air gap 62 between the two. Then, if the first chamber 54 holds engine coolant, which has a relatively high operating temperature, and the second chamber 56 holds coolant for electronics, which has a lower operating temperature, the divider 52 will minimize the heat transfer from the engine coolant to the electronics coolant. Also, the divider 52 does not necessarily divide the container 38 into equal halves. For example, the first chamber 54 for holding the engine coolant may be about four times the volume of the second chamber 56.

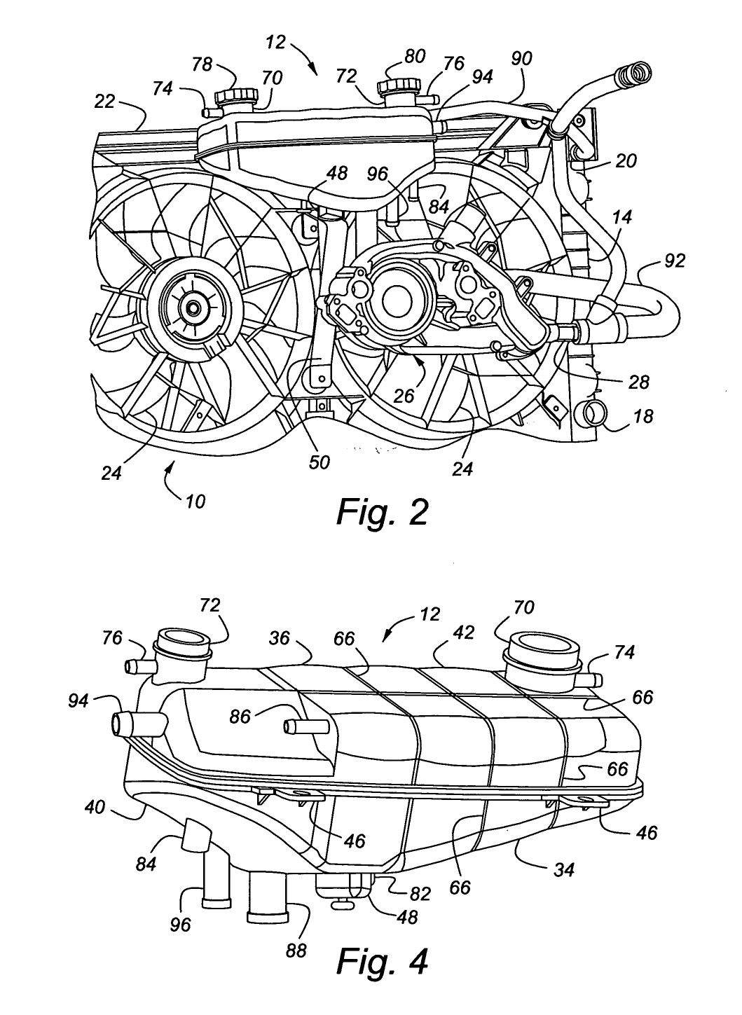

Internal walls 64 may extend within each chamber 54, 56 of the container 38. The interior walls 64 may each have one or more holes 65 of various shapes and sizes, as desired, in order to allow fluid to flow through the chambers 54, 56 to corresponding outlet ports (discussed below). Also, billows 66 (not shown in FIGS. 1 and 2) may extend around portions of the outer wall 36 and coincide with the interior walls 64 to improve manufacturability and strength.

A first filler opening 70 extends from the first chamber 54 through the top of the outer wall 36, and a second filler opening 72 extends from the second chamber 56 through the top of the outer wall 36. The first filler opening 70 includes a first overflow port 74 extending from the first filler opening 70. A first pressure cap 78 (shown in FIGS. 1 and 2) mounts on top of the first filler opening 70 adjacent to the first overflow port 74. The first pressure cap 78 preferably operates similar to conventional radiator caps, with an internal mechanism (not shown) that blocks flow into the first overflow port 74 unless the pressure exceeds a first predetermined pressure, at which point the mechanism will release to allow flow through the first overflow port 74. The second filler opening 72 includes a second overflow port 76 extending from the second filler opening 72. A second pressure cap 80 (shown in FIGS. 1 and 2) mounts on top of the second filler opening 72 adjacent to the second overflow port 76. The second pressure cap 80 operates similar to the first pressure cap 78, but releasing flow to the second overflow port 76 at a second predetermined pressure. Since the engine coolant and electronics coolant operate in different portions of the cooling system 10 and at different operating temperatures, it is likely that the first predetermined pressure will be different than the second predetermined pressure. As an alternative, internal overflow ports (not shown) may be employed with one or both chambers 54, 56 of the tank 12 instead of the first and second overflow ports 74, 76.

The dual surge tank 12 may also include a first sensor port 82 extending from the outer wall 36 into the first chamber 54 and a second sensor port 84 extending from the outer wall 36 into the second chamber 56. The sensor ports 82, 84 allow for the mounting of sensors (not shown) to sense a condition related to the coolants within each of the chambers 54, 56, if so desired.

The first chamber 54 includes a first inlet port 86 and a first outlet port 88 extending therefrom. The first inlet port 86 connects to a radiator overflow hose 90 at a first end, with a second end of the radiator overflow hose 90 connected to the overflow port 20 of the radiator 14. The first outlet port 88 connects to an outlet hose 92 at a first end, with a second end of the outlet hose 92 in fluid communication with the inlet 28 to the water pump assembly 26.

The second chamber 56 includes a second inlet port 94 and a second outlet port 96 extending therefrom. The second inlet port 94 may be connected to a hose (not shown) that is in fluid communication with, for example, a traction power inverter (not shown). The second outlet port 96 may be connected to a hose (not shown) that is in fluid communication with, for example, a low temperature electronic water pump (not shown) or electronic coolant pipe assembly (not shown).

In short, the engine coolant portion of the cooling system 10 is employed to cool engine components similar to a conventional vehicle, and the electronics coolant portion of the cooling system 10 is employed to cool particular electronic components employed, for example, in a hybrid vehicle. The dual surge tank 12, then, provides the functionality of separate surge tanks, while reducing the cost and packaging requirements associated therewith.

While certain embodiments of the present invention have been described in detail, those familiar with the art to which this invention relates will recognize various alternative designs and embodiments for practicing the invention as defined by the following claims.

What is claimed is:

1. A dual surge tank for use in a cooling system of a vehicle comprising:
a housing having an outer wall defining a container;
a divider, located within the housing, dividing the container into a first chamber adapted to contain a first liquid and a second chamber adapted to contain a second liquid, wherein the divider seals the first chamber from the second chamber;
a first filler opening extending through the outer wall into the first chamber; and
a second filler opening extending through the outer wall into the second chamber.

2. The dual surge tank of claim 1 wherein the divider is a heat insulator that is adapted to limit the heat transfer between the first liquid and the second liquid.

3. The dual surge tank of claim 1 wherein the divider includes a first wall adjacent to the first chamber and a second wall, spaced from the first wall, adjacent to the second chamber, with an air gap defined between the first wall and the second wall that forms a heat insulator.

4. The dual surge tank of claim 1 further including a mounting flange extending from the outer wall and adapted to mount to and support the dual surge tank on a fan shroud.

5. The dual surge tank of claim 1 wherein the housing includes an upper clamshell portion and a lower clamshell portion sealingly secured together.

6. The dual surge tank of claim 1 further including a plurality of internal walls extending through the container.

7. The dual surge tank of claim 1 further including a first inlet port extending through the outer wall into the first chamber, a first outlet port extending through the outer wall into the first chamber, a second inlet port extending through the outer wall into the second chamber, and a second outlet port extending through the outer wall into the second chamber.

8. The dual surge tank of claim 1 further including a sensor mounting port extending from the outer wall.

9. The dual surge tank of claim 1 further including a first overflow port operatively engaging the first filler opening, a second overflow port operatively engaging the second filler opening, a first pressure cap operatively engaging the first filler opening and adapted to release under a first pressure, and a second pressure cap operatively engaging the second filler opening and adapted to release under a second pressure that is different than the first pressure.

10. The dual surge tank of claim 1 wherein the first chamber has a volume that is greater than a volume of the second chamber, the first chamber is adapted to receive engine coolant from a radiator, and the second chamber is adapted to receive electronics coolant.

11. The dual surge tank of claim 10 wherein the divider is a heat insulator that is adapted to limit the heat transfer between the engine coolant and the electronics coolant.

12. A dual surge tank for use in a cooling system of a vehicle comprising:
a housing having an outer wall defining a container;
a divider, located within the housing, dividing the container into a first chamber adapted to contain a first liquid and a second chamber adapted to contain a second liquid, wherein the divider seals and is a heat insulator between the first chamber and the second chamber;
a first inlet port and a first outlet port, each extending through the outer wall into the first chamber; and
a second inlet port and a second outlet port, each extending through the outer wall into the second chamber.

13. The dual surge tank of claim 12 wherein the divider includes a first wall adjacent to the first chamber and a second wall, spaced from the first wall, adjacent to the second chamber, with an air gap defined between the first wall and the second wall that forms the heat insulator.

14. The dual surge tank of claim 12 further including a sensor mounting port extending from the outer wall.

15. The dual surge tank of claim 12 further comprising:
a first filler opening extending through the outer wall into the first chamber;
a second filler opening extending through the outer wall into the second chamber;
a first overflow port operatively engaging the first filler opening;
a second overflow port operatively engaging the second filler opening;
a first pressure cap operatively engaging the first filler opening and adapted to release under a first pressure; and
a second pressure cap operatively engaging the second filler opening and adapted to release under a second pressure that is different than the first pressure.

16. The dual surge tank of claim 12 wherein the first chamber has a volume that is greater than a volume of the second chamber, the first chamber is adapted to receive engine coolant from a radiator, and the second chamber is adapted to receive electronics coolant.

17. A cooling system for use in a hybrid vehicle comprising:
a radiator having an overflow port;
a water pump having an inlet; and
a dual surge tank including a housing having an outer wall defining a container; a divider, located within the housing, dividing the container into a first chamber adapted to contain a first liquid and a second chamber adapted to contain a second liquid, wherein the divider seals between the first chamber and the second chamber; a first inlet port extending through the outer wall into the first chamber and in fluid communication with the overflow port of the radiator; a first outlet port extending through the outer wall into the first chamber and in fluid communication with the inlet of the water pump; a second inlet port extending through the outer wall into the second chamber and adapted to allow inflow of the second liquid into the second chamber; and a second outlet port extending through the outer wall into the second chamber and adapted to allow outflow of the second liquid from the second chamber.

18. The cooling system of claim 17 wherein the divider is a heat insulator that is adapted to limit the heat transfer between the first liquid and the second liquid.

19. The cooling system of claim 17 further including a fan shroud and a plurality of mounting flanges extending from the outer wall and mounted to the fan shroud.

20. The cooling system of claim 17 further comprising:
a first filler opening extending through the outer wall into the first chamber;
a second filler opening extending through the outer wall into the second chamber;
a first overflow port operatively engaging the first filler opening;
a second overflow port operatively engaging the second filler opening;
a first pressure cap operatively engaging the first filler opening and adapted to release under a first pressure; and
a second pressure cap operatively engaging the second filler opening and adapted to release under a second pressure that is different than the first pressure.
